(19) United States
(12) Patent Application Publication
(10) Pub. No.: US 2025/0386135 A1
(43) Pub. Date: Dec. 18, 2025

(54) VIBRATION SYSTEM AND LOUDSPEAKER

(71) Applicants: Yongchun ZHANG, Shuangcheng, Heilongjiang (CN); Shenzhen Xinqi Science and Technology Co., Ltd., Shenzhen City, Guangdong (CN)

(72) Inventor: Yongchun ZHANG, Shuangcheng, Heilongjiang (CN)

(73) Assignee: Shenzhen Xinqi Science and Technology Co., Ltd., Shenzhen City, Guangdong (CN)

(21) Appl. No.: 18/879,586

(22) PCT Filed: Jul. 14, 2022
(86) PCT No.: PCT/CN2022/105709

§ 371 Date: Dec. 27, 2024

(30) Foreign Application Priority Data
Jun. 28, 2022 (CN) 202210742511.5

(51) Int. Cl. H04R 1/28; H04R 7/06; H04R 7/18; H04R 9/06

(52) U.S. Cl. CPC H04R 1/2896; H04R 7/06; H04R 7/18; H04R 9/06; H04R 2400/11

(57) ABSTRACT

A system including: a first damper attached to a support frame; a drive component penetrates the support frame and the first damper; a diaphragm holder having a first frame part, a framework unit, and a fixing part connected to the first frame part by the framework unit; the diaphragm holder connected to the first damper; the fixing part is connected to one end of the drive component; a diaphragm assembly having a diaphragm unit and an annular diaphragm; a phase ball assembly attached to the side of the annular diaphragm closer to the diaphragm holder; a second damper sleeved on the outside of the diaphragm holder, the diaphragm assembly. the phase ball assembly, and the first damper: the side in the second damper facing the diaphragm holder is connected to the diaphragm holder and the side in the second damper facing the support frame is connected to the support frame.

### TECHNICAL FIELD

The present disclosure belongs to the technical field of speakers, and specifically relates to a vibration system and a speaker.

### BACKGROUND

As a key component of audio equipment, the structure, shape and the like of a speaker unit directly affect the performance, design scheme, manufacturing, and assembly of the audio system. At present, a vibration system of traditional speaker units includes components such as membrane, folding ring, centering support plate, and voice coil. However, the following problems still exist: the membrane of traditional speakers is generally a complete sheet material having a cone-shaped structure, and the voice coil is directly adhered to the membrane to push it to produce sound. Due to the limitations of the material itself, this structure will produce segmentation vibration, and the energy distribution from the position of the voice coil to the folding ring at the edge will decrease gradually, resulting in energy imbalance, thereby reducing the stability of the speaker and improving the distortion rate. A damper of traditional speakers includes a centering support plate and a folding ring. The centering support plate of existing speakers is prone to aging, that is, the fatigue resistance gradually decreases with use time. Moreover, the centering support plate of existing speakers is adhered to the skeleton of the voice coil, which causes the centering support plate to occupy the position of the voice coil, resulting in a thicker overall structure of the speaker. In addition, the existing speakers lack phase correction measures, which leads to severe phase distortion and sound interference in the speakers.

### SUMMARY

An object of the present disclosure is to at least solve the problems of high distortion rate, overly thick structural dimensions, and poor stability of existing speakers. This object is achieved through the following technical solutions.

A first aspect of the present disclosure provides a vibration system and a speaker, which includes:
a support frame;
at least one first damper, which is attached to one side of the support frame;
a drive component with the same number as the first damper, one end of the drive component passing through the support frame and the first damper in sequence;
a membrane holder, which includes a first holder portion, as well as a skeleton portion group and a fixing portion both located within the first holder portion, the number of the fixing portion being the same as that of the first damper; in which the fixing portion is connected to the first holder portion through the skeleton portion group, one side of the membrane holder is connected to the first damper located on the support frame, and the fixing portion is connected to said one end of the drive component;
a membrane assembly, which includes a membrane group, and an annular membrane with the same number as the first damper; in which the membrane group is arranged around the circumference of the annular membrane, and the membrane group and the annular membrane together are attached to one side of the skeleton portion group and the fixing portion that is away from the first damper;
a phase ball assembly with the same number as the first damper; in which the phase ball assembly is attached to one side of the annular membrane that is close to the membrane holder, and partially extends to the other side of the annular membrane; and
a second damper, which is sleeved on the outer side of the membrane holder, the membrane assembly, the phase ball assembly and the first damper, one side of the second damper that faces the membrane holder being connected to the membrane holder, and one side of the second damper that faces the support frame being connected to the support frame.

When using the vibration system and the speaker of this technical solution, a combination structure of the support frame, the first damper, the drive component, the membrane holder, the membrane assembly, the phase ball assembly, and the second damper is adopted. The drive component can receive alternating current and generate an electromagnetic field, thereby causing the drive component to vibrate and drive the membrane assembly on the membrane holder to vibrate, ultimately achieving the transduction effect of the speaker. The support frame is used to fix the drive component, the first damper, the membrane holder, the membrane assembly and the second damper respectively, enhancing the stability of the speaker. The first damper is directly connected to the support frame, so that the position of the drive component is no longer occupied and thus it is not required to reserve a thickness space, making the overall structure of the speaker tend to be ultra-thin and improving convenience. The membrane holder is used to fix the membrane assembly and the phase ball assembly, enhancing the stability therebetween. At the same time, the speaker can also achieve a low distortion effect, improving the sound quality of the speaker. In addition, when the vibration frequency of the phase ball assembly is coupled with a preset frequency, its vibration direction deviates from the vibration direction of the membrane, and a phase difference is generated, thereby achieving the correction or cancellation of phase distortion at specific frequencies and improving the sound quality of the speaker. The membrane assembly adopts a combination structure of the membrane group and the annular membrane, which can reduce the segmentation vibration of the membrane assembly and improve the rigidity modulus.

In addition, the speaker according to the present disclosure may also have the following additional technical features.

In some embodiments of the present disclosure, the support frame includes a second frame portion, several support portions, and several installation portions; the number of the installation portions is the same as the number of the first dampers, and the installation portions are arranged concentric with the drive components; the installation portions are located within the second frame portion, and the outer side of the periphery of the installation portions is connected to the second frame portion; the several support portions are arranged around the outer periphery of the second frame portion on a side close to the first damper.

In some embodiments of the present disclosure, the installation portion includes several annular portions, and a first connection portion having a first inner hole; the several annular portions are arranged around the circumference of the first connection portion and connected to the second frame portion, and the first inner hole is cooperated and concentric with the drive component.

In some embodiments of the present disclosure, the first damper includes a second connection portion having a second inner hole, and piston portions with the same number as the annular portions; the several piston portions are arranged around the circumference of the second connection portion; the piston portions are located within the annular portions and are arranged concentric with the annular portions; the second connection portion is attached to one side of the first connection portion that is close to the membrane holder, and the second inner hole is cooperated and concentric with the drive component.

In some embodiments of the present disclosure, the fixing portion has a third inner hole therein, and a skeleton portion group is connected between the first holder portion and the fixing portion; the membrane group is attached to the skeleton portion group and can block the skeleton portion group, and the annular membrane is attached to the fixing portion and can block the third inner hole; the third inner hole is cooperated and concentric with the drive component.

In some embodiments of the present disclosure, the membrane holder further includes several connecting rod portions; the several connecting rod portions are located on a side of the skeleton portion group located between the outer periphery of the third inner hole and the first holder portion that faces the first damper in a surrounding manner; the connecting rod portions can pass through the first damper and the support frame in sequence and be damped and positioned by the first damper for balance and fixation.

In some embodiments of the present disclosure, the phase ball assembly is arranged concentric with the drive component, and includes a mass ball and an annular elastic rubber ring having an installation hole; the mass ball is located within the installation hole and connected to the annular elastic rubber ring.

In some embodiments of the present disclosure, the second damper is a first annular structure; the first annular structure includes a third connection portion, a transition portion, and a fourth connection portion; the transition portion is connected to the third connection portion and the fourth connection portion respectively, the third connection portion is connected to the support frame, and the fourth connection portion is connected to the membrane holder.

In some embodiments of the present disclosure, the second damper is a second annular structure; the second annular structure includes a fifth connection portion, a corrugated portion provided with spherical structures, and a sixth connection portion; the corrugated portion is connected to the fifth connection portion and the sixth connection portion respectively, the fifth connection portion is connected to the support frame, and the sixth connection portion is connected to the membrane holder.

The present disclosure also provides a speaker, which includes the vibration system as described in any one of the above items.

### BRIEF DESCRIPTION OF THE DRAWINGS

Upon reading the detailed description of the preferred embodiments below, various other advantages and benefits will become clear to those skilled in the art. The accompanying drawings are only used for the purpose of illustrating preferred embodiments, and should not be considered as a limitation to the present disclosure. Moreover, throughout the drawings, the same reference signs are used to denote the same components. In the drawings:

FIG. 1 shows a schematic view of the overall structure of the vibration system according to an embodiment of the present disclosure;

FIG. 2 is a schematic view of the overall structure of the vibration system in FIG. 1 from another perspective;

FIG. 3 is a schematic view of the exploded structure of the vibration system in FIG. 1;

FIG. 4 is a schematic view of the combination structure of the membrane holder, membrane assembly, phase ball assembly, and second damper in FIG. 3;

FIG. 5 is a schematic view of the combination structure of the membrane holder, membrane assembly, phase ball assembly, first damper, and second damper in FIG. 4 from another perspective;

FIG. 6 is a schematic view of the overall structure of the membrane holder of the vibration system in FIG. 3;

FIG. 7 is a schematic view of the overall structure of the membrane holder in FIG. 6 from another perspective;

FIG. 8 is a schematic view of the overall structure of another embodiment of the membrane holder of the vibration system in FIG. 3;

FIG. 9 is a schematic view of the overall structure of a single first damper of the vibration system in FIG. 3;

FIG. 10 is a schematic view of the overall structure of a dual-engine first damper array combination of the vibration system in FIG. 3;

FIG. 11 is a schematic view of the combination structure of the first damper and the membrane unit in FIG. 3;

FIG. 12 is a schematic view of the combination structure of the first damper and the support frame in FIG. 3;

FIG. 13 is a schematic view of the overall structure of the membrane assembly in FIG. 3;

FIG. 14 is a schematic view of the cross-sectional structure of the second damper in FIG. 3;

FIG. 15 shows a schematic view of the overall structure of the speaker according to another embodiment of the present disclosure (with the second damper being a second annular structure);

FIG. 16 is a schematic view of the overall structure of another embodiment of the second damper in FIG. 15; and

FIG. 17 is a schematic view of the cross-sectional structure of another embodiment of the second damper in FIG. 16.

### LIST OF REFERENCE SIGNS

100: vibration system;
10: support frame; 11: second frame portion; 12: installation portion; 121: first connection portion; 1211: first inner hole; 122: annular portion; 13: support portion;
20: first damper; 21: second connection portion; 211: second inner hole; 22: piston portion;
30: drive component; 31: magnetic conductor; 311: installation chamber; 32: magnet; 33: washer; 34: short-circuit ring; 35: voice coil; 36: electrical connector;
40: membrane unit; 41: membrane holder; 411: first holder portion; 412: fixing portion; 4121: third inner hole; 413: skeleton portion group; 414: hollow structure; 415: connecting rod portion; 42: phase ball assembly; 421: mass ball; 422: annular elastic rubber ring; 43: membrane assembly; 431: annular membrane; 432: membrane group;
51: first annular structure; 511: third connection portion; 512: transition portion; 513: fourth connection portion; 52: second annular structure; 521: fifth connection portion; 522: corrugated portion; 5221: spherical structure; 523: sixth connection portion.

### DETAILED DESCRIPTION

Hereinafter, exemplary embodiments of the present disclosure will be described in greater detail with reference to the accompanying drawings. Although the exemplary embodiments of the present disclosure are shown in the drawings, it should be understood that the present disclosure may be implemented in various forms and should not be limited by the embodiments set forth herein. On the contrary, these embodiments are provided to enable a more thorough understanding of the present disclosure and to fully convey the scope of the present disclosure to those skilled in the art.

It should be understood that the terms used herein are only for the purpose of describing specific exemplary embodiments, and are not intended to be limitative. Unless clearly indicated otherwise in the context, singular forms “a”, “an”, and “said” as used herein may also mean that plural forms are included. Terms “include”, “comprise”, “contain” and “have” are inclusive, and therefore indicate the existence of the stated features, steps, operations, elements and/or components, but do not exclude the existence or addition of one or more other features, steps, operations, elements, components, and/or combinations thereof. The method steps, processes, and operations described herein should not be interpreted as requiring them to be executed in the specific order described or illustrated, unless the order of execution is clearly indicated. It should also be understood that additional or alternative steps may be used.

Although terms “first”, “second”, “third” and the like may be used herein to describe multiple elements, components, regions, layers and/or sections, these elements, components, regions, layers and/or sections should not be limited by these terms. These terms may only be used to distinguish one element, component, region, layer or section from another region, layer or section. Unless clearly indicated in the context, terms such as “first”, “second” and other numerical terms do not imply an order or sequence when they are used herein. Therefore, the first element, component, region, layer or section discussed below may be referred to as a second element, component, region, layer or section without departing from the teachings of the exemplary embodiments.

For ease of description, spatial relative terms may be used herein to describe the relationship of one element or feature relative to another element or feature as shown in the drawings. These relative terms are, for example, “inner”, “outer”, “inside”, “outside”, “below”, “under”, “above”, “over”, etc. These spatial relative terms are intended to include different orientations of the device in use or in operation in addition to the orientation depicted in the drawings. For example, if the device in the figure is turned over, then elements described as “below other elements or features” or “under other elements or features” will be oriented “above the other elements or features” or “over the other elements or features”. Thus, the exemplary term “below” may include orientations of both above and below. The device can be otherwise oriented (rotated by 90 degrees or in other directions), and the spatial relationship descriptors used herein will be explained accordingly.

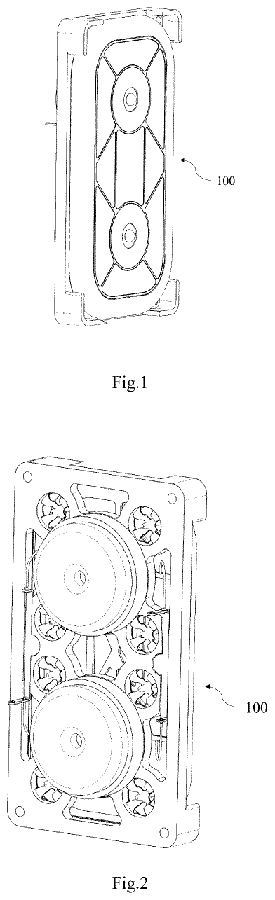

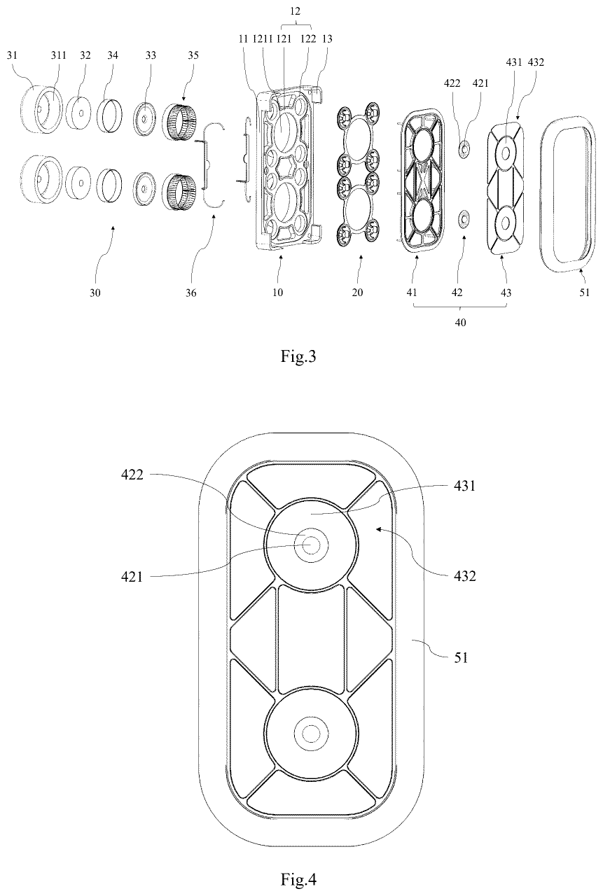

FIG. 1 shows a schematic view of the overall structure of the vibration system according to an embodiment of the present disclosure. FIG. 2 is a schematic view of the overall structure of the vibration system in FIG. 1 from another perspective. FIG. 3 is a schematic view of the exploded structure of the vibration system in FIG. 1. As shown in FIGS. 1, 2, and 3, the present disclosure provides a vibration system 100. The vibration system 100 in the present disclosure includes a support frame 10, at least one first damper 20, a drive component 30 with the same number as the first damper 20, a membrane holder 41, a membrane assembly 43, a phase ball assembly 42 with the same number as the first damper 20, and a second damper 51. The first damper 20 is attached to one side of the support frame 10. One end of the drive component 30 (i.e., one end of a voice coil 35) passes through the support frame 10 and the first damper 20 in sequence, and is connected to the membrane holder 41.

The membrane holder 41 includes a first holder portion 411, as well as a skeleton portion group 413 and a fixing portion 412 both located within the first holder portion 411, the fixing portion 412 having the same number as the first damper 20. The fixing portion 412 is connected to the first holder portion 411 through the skeleton portion group 413. Connecting rod portions 415 of the membrane holder 41 are connected to the first damper 20 located on the support frame 10. The fixing portion 412 is connected to one end of the drive component 30 (i.e., one end of the voice coil 35). The membrane assembly 43 includes a membrane group 432 and an annular membrane 431 with the same number as the first damper 20. The membrane group 432 surrounds the annular membrane 431 along a circumferential direction of the annular membrane 431, and the membrane group 432 and the annular membrane 431 together are attached to one side of the skeleton portion group 413 and the fixing portion 412 that is away from the first damper 20. The phase ball assembly 42 is attached to one side of the annular membrane 431 that is close to the membrane holder 41, and partially extends to the other side of the annular membrane 431. The second damper is sleeved on the outer side of the membrane holder 41, the membrane assembly 43, the phase ball assembly 42 and the first damper 20. A fourth connection portion 513 of the second damper that faces the membrane holder 41 is connected to the membrane holder 41, and a third connection portion 511 of the second damper that faces the support frame 10 is connected to the support frame 10.

When using the vibration system 100 of this technical solution, a combination structure of the support frame 10, the first damper 20, the drive component 30, the membrane holder 41, the membrane assembly 43, the phase ball assembly 42, and the second damper 51 is adopted. The drive component 30 can receive alternating current and generate an electromagnetic field, thereby causing the voice coil 35 in the drive component 30 to vibrate and drive the first damper 20, the membrane unit 40 (the membrane holder 41, the phase ball assembly 42, and the membrane assembly 43) and the second damper to vibrate, ultimately achieving the transduction effect of the speaker. The support frame 10 is used to fix the drive component 30, the first damper 20, the membrane unit 40, and the second damper respectively, enhancing the stability of the overall vibration system 100. The first damper 20 is directly connected to the support frame 10, so that the position of the drive component 30 is no longer occupied and thus it is not required to reserve a thickness space, making the overall structure of the vibration system 100 tend to be ultra-thin and improving convenience. The membrane holder 41 is used to fix the membrane assembly 43 and the phase ball assembly 42, enhancing the stability therebetween and further strengthening the rigidity modulus of the membrane assembly 43. At the same time, the arrangement of the phase ball assembly 42 also enables the overall vibration system 100 to achieve a low distortion effect, improving the sound quality of the vibration system 100. In addition, when the vibration frequency of the phase ball assembly 42 is coupled with a preset frequency, its vibration direction deviates from the vibration direction of the membrane, and a phase difference is generated, thereby achieving the correction or cancellation of phase distortion at specific frequencies and improving the sound quality of the vibration system 100. The membrane assembly 43 adopts a combination structure of the membrane group 432 and the annular membrane 431, which can reduce the segmentation vibration of the membrane assembly 43 and improve the rigidity modulus.

Specifically, in the present disclosure, the membrane holder 41, the membrane assembly 43 and the phase ball assembly 42 can be collectively referred to as a membrane unit 40.

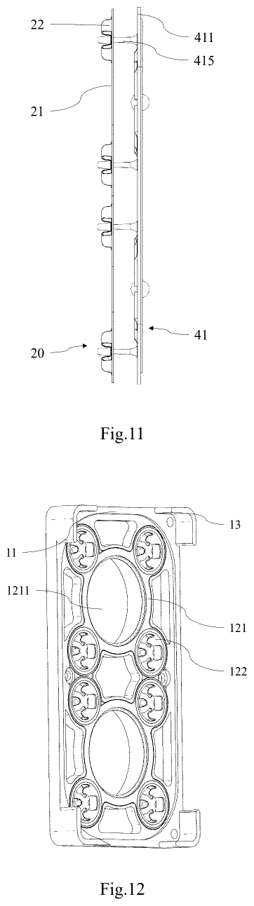

In some embodiments of the present disclosure, as shown in FIGS. 3 and 12, the support frame 10 includes a second frame portion 11, several support portions 13, and several installation portions 12. The number of the installation portions 12 is the same as the number of the first dampers 20, and the installation portions 12 are arranged concentric with the drive components 30. The installation portions 12 are located within the second frame portion 11, and the outer side of the periphery of the installation portions 12 is connected to the second frame portion 11. The several support portions 13 are arranged around the outer periphery of the second frame portion 11 on a side close to the first damper 20. In this embodiment, a side of the installation portions 12 that faces the first damper 20 is used to fixedly connect the first damper 20 by adhesive or other connection methods. The several support portions 13 can define the first damper 20, the membrane unit 40 and the second damper inside it respectively, thereby protecting the first damper 20, the membrane unit 40 and the second damper. At the same time, the several support portions 13 can also be connected to other components of the speaker to achieve the fixation and installation of the vibration system 100.

In some embodiments of the present disclosure, as shown in FIGS. 3 and 12, the installation portion 12 includes several annular portions 122, and a first connection portion 121 having a first inner hole 1211. The several annular portions 122 are arranged around the circumference of the first connection portion 121 and connected to the second frame portion 11. The first inner hole 1211 is cooperated and concentric with the drive component 30. In this embodiment, the first connection portion 121 is used to connect with the first damper 20, thereby achieving the connection between the first damper 20 and the support frame 10. The several annular portions 122 are arranged around the circumference of the first connection portion 121 and connected with the first connection portion 121 and the second frame portion 11 respectively. The several annular portions 122 can correspond to piston portions 22 of the first damper 20, so that the first damper 20 can provide piston movement when the vibration system 100 emits a sound, and provide specific smoothness and damping for the membrane unit 40 connected to it, thereby improving the stability of the structure of the overall vibration system 100, while also enhancing sound quality and reducing distortion rate. The first inner hole 1211 is arranged concentric with the drive component 30, thereby accurately positioning the voice coil 35 of the drive component 30, and improving the precision of assembly and the linear piston movement of the voice coil 35.

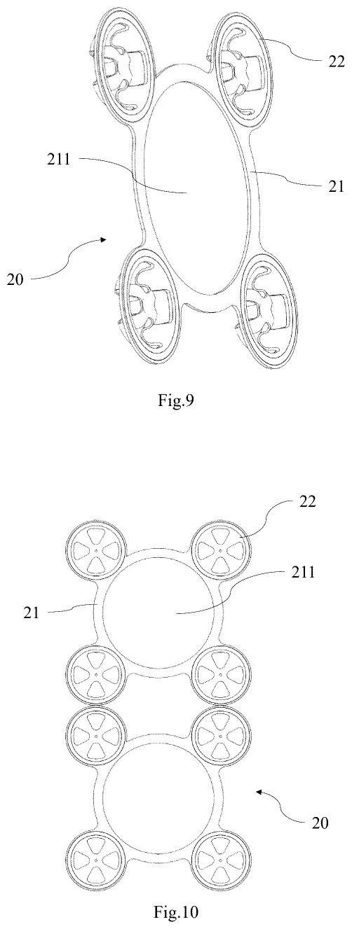

In some embodiments of the present disclosure, as shown in FIGS. 9 and 10, the first damper 20 includes a second connection portion 21 having a second inner hole 211, and piston portions 22 with the same number as the annular portions 122. The several piston portions 22 are arranged around the circumference of the second connection portion 21. The piston portions 22 are located within the annular portions 122 and are arranged concentric with the annular portions 122. The second connection portion 21 is attached to a side of the first connection portion 121 that is close to the membrane holder 41. The second inner hole 211 is arranged concentric with the voice coil 35 of the drive component 30. In this embodiment, the second connection portion 21 is bonded to the first connection portion 121, and the piston portions 22 are arranged around the circumference of the second connection portion 21 and located within the annular portions 122 respectively. When the vibration system 100 vibrates and emits a sound, the piston portions 22 located within the annular portions 122 of the first damper 20 can move and provide specific smoothness and damping for the membrane unit 40 connected to it.

Specifically, traditional dampers include a centering support plate and a folding ring, which are completely replaced in a new form in this embodiment. The first damper 20 in this embodiment is no longer attached to the voice coil 35 in the drive component 30 like the centering support plate, so the first advantage is that it no longer occupies the position between the drive component 30 and the membrane, and there is no need to reserve a thickness space, making the overall structure of the vibration system 100 tend to be ultra-thin. At the same time, due to the fact that the first damper 20 no longer uses various cotton fiber fabrics for impregnating and hot-pressing molding, which is commonly used in the centering support plate, but elastic rubber vulcanization molding is used instead, the first damper 20 is no longer prone to aging and fatigued short life like the centering support plate. At the same time, it also has good elasticity, which facilitates vibration and produces specific smoothness and damping, improving the sound quality of the vibration system 100 and reducing distortion rate.

Specifically, in this embodiment, the piston portion 22 is composed of a ring-like corrugated sheet, and a circular hole is provided at the center to accommodate the connecting rod portion 415 of the membrane holder 41. In addition, the piston portion 22 is also provided with petal-like openings to reduce wind resistance and improve smoothness.

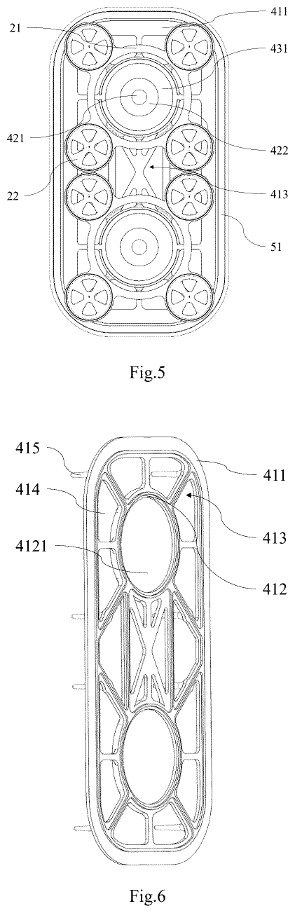

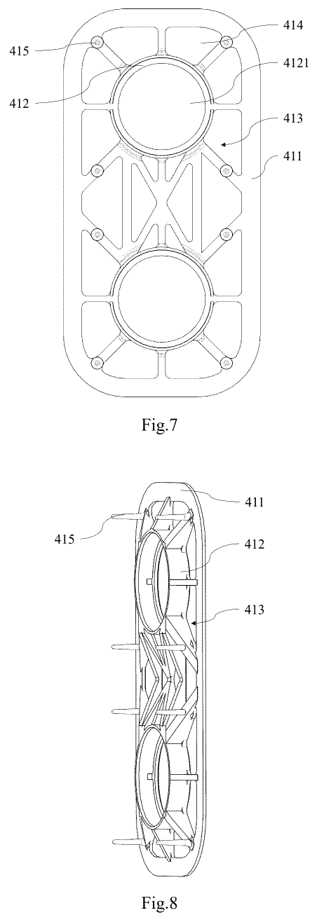

In some embodiments of the present disclosure, as shown in FIGS. 6 and 7, the fixing portion 412 has a third inner hole 4121 therein, and a skeleton portion group 413 is connected between the first holder portion 411 and the fixing portion 412. The membrane group 432 is attached to the skeleton portion group 413 and can block the skeleton portion group 413, and the annular membrane 431 is attached to the fixing portion 412 and can block the third inner hole 4121. The third inner hole 4121 is cooperated and concentric with the drive component 30. In this embodiment, the fixing portion 412 is used to connect and fix the voice coil 35 in the drive component 30, and the skeleton portion group 413 is connected to the first holder portion 411 and the fixing portion 412 respectively. The membrane holder 41 of the overall structure in this embodiment can withstand large loads without easy deformation, while also increasing the load-bearing power.

Specifically, in this embodiment, as shown in FIGS. 6 and 7, the membrane holder 41 is a truss structure. The skeleton portion group 413 consists of several intersecting horizontal and vertical or triangular, circular, and other irregularly shaped keels (ribs) with hollow structures 414 provided on them, forming a rigid member as a whole. One side of the skeleton portion group 413 is attached to the membrane, and the fixing portion 412 on the other side is used to install the voice coil 35 in the drive component 30, so that large loads can be withstood and the stability performance of the overall vibration system 100 can be improved.

Specifically, in this embodiment, as shown in FIGS. 6, 7, and 8, the membrane holder 41 can be designed in two modes: a planar structure and a three-dimensional structure. Both modes take the annular fixing portion 412 connected to the voice coil 35 in the drive component 30 as the mechanical center and uniformly diffuse and propagate the mechanical force or acoustic energy from the drive component 30 to the entire truss network. As shown in FIG. 6, all skeleton portion groups 413 of the membrane holder 41 having the planar structure are in the same plane. As shown in FIG. 8, the skeleton portion groups 413 of the membrane holder 41 having the three-dimensional structure are located in different planes. An end face of the annular fixing portion 412 that is connected to the voice coil 35 in the drive component 30 is located in a lower plane, while the second frame portion 11 that is connected to the second damper is located in a higher plane (i.e., the second frame portion 11 has a larger height facing the second damper than the fixing portion 412). The skeleton portion groups 413 that connect the second frame portion 11 with the fixing portion 412 gradually transition smoothly from a lower plane to a higher plane.

In some embodiments of the present disclosure, as shown in FIGS. 6 and 7, the membrane holder 41 further includes several connecting rod portions 415. The several connecting rod portions 415 are located on a side of the skeleton portion group 413 located between the outer periphery of the third inner hole 4121 and the first holder portion 411 that faces the first damper 20 in a surrounding manner. The connecting rod portions 415 can pass through the first damper 20 and the support frame 10 in sequence and be damped and positioned by the first damper 20 for balance and fixation. In this embodiment, as shown in FIG. 11, the several connecting rod portions 415 are used to correspondingly cooperate with the piston portions 22 of the first damper 20, so that they can be limited by the first damper 20. Therefore, on the basis that the piston portions 22 of the first damper 20 can vibrate axially along their respective centerline directions, it is ensured that the entire vibration system is also limited and simultaneously vibrates axially. That is, when the vibration system 100 vibrates and emits a sound, it provides piston movement and produces specific smoothness and damping, thereby improving the sound quality effect and reducing the distortion rate.

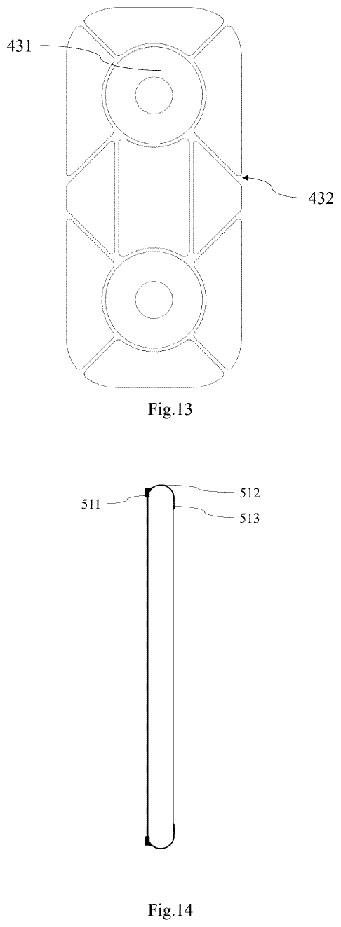

Further, in this embodiment, as shown in FIG. 13, the membrane assembly 43 is a spliced structure, including the annular membrane 431 and the membrane group 432. The membrane group 432 is arranged around the circumference of the annular membrane 431, and the membrane group 432 also includes various shapes of membranes. That is, in the membrane assembly 43, according to the requirements of the skeleton portion group 413 of the membrane holder 41, including different areas, limited shapes, and mechanical conductivity coefficients, a sheet plate made of the same or different materials is cut into several sheets having different cross-sectional shapes. The cut sheets are then spliced together like a puzzle on the top of the membrane holder 41 to finally form a closed plane, which forms the vibration system 100 together with the membrane holder 41, the first damper 20 and the second damper, so that the segmentation vibration of the membrane assembly 43 can be reduced and the rigidity modulus can be improved.

Specifically, in this embodiment, in addition to using a uniform material, the membrane assembly 43 can also be constructed by laminating multiple composite materials having different materials, thicknesses, or sandwich-like structures. By adjusting the mechanical conductivity coefficient and thermal balance through different materials, thicknesses, etc., uniform energy distribution can be achieved and distortion can be reduced.

In some embodiments of the present disclosure, the annular membrane 431 is arranged concentric with the voice coil 35 in the drive component 30, which can ensure the stability and reliability of the vibration system 100 during the vibration.

In some embodiments of the present disclosure, as shown in FIGS. 3 and 4, the phase ball assembly 42 is arranged concentric with the drive component 30, and includes a mass ball 421 and an annular elastic rubber ring 422 having an installation hole. The mass ball 421 is located within the installation hole and connected to the annular elastic rubber ring 422. In this embodiment, the phase ball assembly 42 is a spherical or hemispherical oscillation device specially designed for eliminating acoustic interference, and its principle is similar to the Tuned Mass Damper (TMD) inside a skyscraper. The phase ball assembly 42 is composed of a combination of the mass ball 421 and the annular elastic rubber ring 422. The mass ball 421 provides resonant mass, and the annular elastic rubber ring 422 acts like a spring, providing elasticity and damping for the mass ball 421 and adhering to a specific membrane assembly 43. The phase ball assembly 42, a special device, is mainly used to eliminate phase distortion and other problems in subwoofer speakers or large aperture mid-range and woofer speakers. In its operation, when the vibration frequency is coupled with a preset frequency, its vibration direction deviates from the vibration direction of the membrane and a phase difference is generated. When the phase difference reaches about 90°-180°, its effect also reaches the best and corrects, couples or cancels out the phase of a specific frequency, thereby reducing the acoustic interference of the membrane assembly 43 caused by phase distortion.

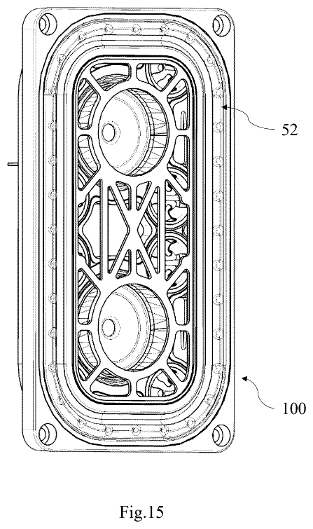

In some embodiments of the present disclosure, as shown in FIGS. 3 and 14, the second damper is a first annular structure 51. The first annular structure 51 includes a third connection portion 511, a transition portion 512, and a fourth connection portion 513. The transition portion 512 is connected to the third connection portion 511 and the fourth connection portion 513 respectively. The third connection portion 511 is connected to the support frame 10, and the fourth connection portion 513 is connected to the membrane holder 41. In this embodiment, as shown in FIGS. 4 and 5, the first annular structure 51 is formed from a perspective perpendicular to the membrane assembly 43 or the membrane holder 41, which appears to be 90 degrees away from traditional dampers. The main purpose of the second damper is to connect the support frame 10 and the membrane holder 41 in a closed manner, and reduce the cross-sectional area occupied by the second damper while ensuring the smoothness and damping. The reduced cross-sectional area is compensated to the membrane assembly 43 to increase the effective cross-sectional area of the membrane assembly 43.

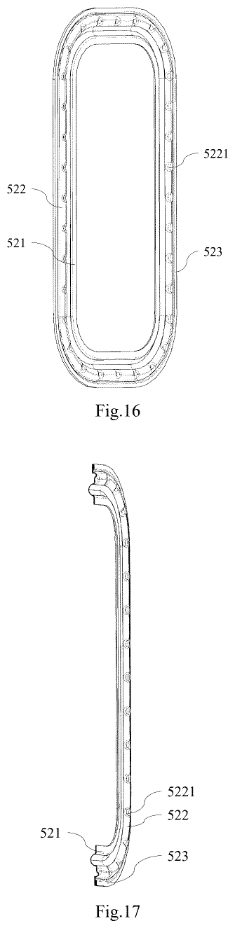

In some embodiments of the present disclosure, as shown in FIGS. 15, 16 and 17, when the support frame 10 of the vibration system is applied in another embodiment, the second damper is a second annular structure 52. The second annular structure 52 includes a fifth connection portion 521, a corrugated portion 522, and a sixth connection portion 523. The corrugated portion 522 is connected to the fifth connection portion 521 and the sixth connection portion 523 respectively. The fifth connection portion 521 is connected to the membrane holder 41, and the sixth connection portion 523 is connected to the support frame 10. In this embodiment, the second annular structure 52 is formed from a perspective perpendicular to the membrane assembly 43 or the membrane holder 41. The second damper of the second annular structure 52 is a simplified replacement for the second damper of the first annular structure 51. That is, when the support frame 10 is applied in another embodiment, the second annular structure 52 of this solution is adopted. The second annular structure 52 in this embodiment does not have the advantage of the first annular structure 51 in reducing its own cross-sectional area or increasing the cross-sectional area of the membrane assembly 43, but can still connect the support frame 10 and the membrane holder 41 in a closed manner. The corrugated portion in this embodiment includes peak portions and valley portions, and the peak portions are also provided with spherical structures 5221.

In some embodiments of the present disclosure, as shown in FIG. 3, the drive component 30 includes a magnetic conductor 31, a magnet 32, a washer 33, and a voice coil 35. The magnetic conductor 31 is provided therein with an installation chamber 311, in which the magnet 32 and the washer 33 are sequentially arranged along an axial direction of the magnetic conductor 31. One end of the voice coil 35 is inserted to a gap formed between the washer 33 and the magnetic conductor 31, and the other end of the voice coil 35 is connected to the membrane unit 40 and can move back and forth in a straight line along the axial direction of the magnetic conductor 31. The magnet 32 and the washer 33 are attached to each other and jointly installed in the installation chamber 311, forming a magnetic gap with an inner wall of the magnetic conductor 31 in a spaced-apart manner, ensuring that the voice coil 35 can be inserted to the magnetic gap formed between the magnetic conductor 31, the magnet 32 and the washer 33, and vibrate back and forth along its own axial direction. Specifically, one end of the voice coil 35 is inserted to the magnetic gap formed between the magnetic conductor 31, the magnet 32 and the washer 33, and the other end of the voice coil 35 can pass through the second frame portion 11 and the second inner hole 211, and finally match with the third inner hole 4121 to drive the membrane unit 40.

Specifically, as shown in FIG. 3, the drive component 30 also includes an electrical connector 36. One end of the electrical connector 36 is connected to the voice coil 35, and the other end of the electrical connector 36 is connected to an external amplifying power source. The electrical connector 36 can provide alternating current to the voice coil 35 and cause it to vibrate, ultimately achieving the effect of “electric-force-sound” transduction and sound amplification of the vibration system 100.

Specifically, in other embodiments of the present disclosure, the membrane holder 41 and the membrane assembly 43 in the vibration system 100 can also be integrally formed using the same material through a mold.

Further, in an embodiment of the present disclosure, the numbers of the first damper 20, the drive component 30, the installation portion 12, the second connection portion 21, the fixing portion 412, the phase ball assembly 42, and the annular membrane 431 are each two, and the numbers of the piston portion 22 and the annular portion 122 are both four. In other embodiments of the present disclosure, the above-mentioned components can be used in an array without limitation.

The present disclosure also proposes a speaker, which has the vibration system 100 as described above.

When using the speaker of this technical solution, a combination structure of the support frame 10, the first damper 20, the drive component 30, the membrane holder 41, the membrane assembly 43, the phase ball assembly 42, and the second damper is adopted. The drive component 30 can receive alternating current and generate an electromagnetic field, thereby causing the voice coil 35 in the drive component 30 to vibrate and drive the first damper 20, the membrane unit 40 (the membrane holder 41, the phase ball assembly 42, and the membrane assembly 43) and the second damper to vibrate, ultimately achieving the transduction effect of the speaker. The support frame 10 is used to fix the drive component 30, the first damper 20, the membrane unit 40, and the second damper respectively, enhancing the stability of the overall speaker. The first damper 20 is directly connected to the support frame 10, so that the position of the drive component 30 is no longer occupied and thus it is not required to reserve a thickness space, making the overall structure of the speaker tend to be ultra-thin and improving convenience. The membrane holder 41 is used to fix the membrane assembly 43 and the phase ball assembly 42, enhancing the stability therebetween and further strengthening the rigidity modulus of the membrane assembly 43. At the same time, the arrangement of the phase ball assembly 42 also enables the overall speaker to achieve a low distortion effect, improving the sound quality of the speaker. In addition, when the vibration frequency of the phase ball assembly 42 is coupled with a preset frequency, its vibration direction deviates from the vibration direction of the membrane, and a phase difference is generated, thereby achieving the correction or cancellation of phase distortion at specific frequencies and improving the sound quality of the speaker. The membrane assembly 43 adopts a combination structure of the membrane group 432 and the annular membrane 431, which can reduce the segmentation vibration of the membrane assembly 43 and improve the rigidity modulus.

Described above are only preferred specific embodiments of the present disclosure, but the scope of protection of the present disclosure is not limited to this. Any changes or replacements that can be easily conceived by those skilled in the art within the technical scope disclosed by the present disclosure should be covered within the scope of protection of the present disclosure. Therefore, the scope of protection of the present disclosure should be accorded with the scope of protection of the claims.

1. A vibration system, comprising:
a support frame;
at least one first damper, which is attached to one side of the support frame;
a drive component with the same number as the first damper, one end of the drive component passing through the support frame and the first damper in sequence;
a membrane holder, which comprises a first holder portion, as well as a skeleton portion group and a fixing portion both located within the first holder portion, the number of the fixing portion being the same as that of the first damper; wherein the fixing portion is connected to the first holder portion through the skeleton portion group, one side of the membrane holder is connected to the first damper located on the support frame, and the fixing portion is connected to said one end of the drive component;
a membrane assembly, which comprises a membrane group, and an annular membrane with the same number as the first damper; wherein the membrane group is arranged around the circumference of the annular membrane, and the membrane group and the annular membrane together are attached to one side of the skeleton portion group and the fixing portion that is away from the first damper;
a phase ball assembly with the same number as the first damper; wherein the phase ball assembly is attached to one side of the annular membrane that is close to the membrane holder, and partially extends to the other side of the annular membrane; and
a second damper, which is sleeved on the outer side of the membrane holder, the membrane assembly, the phase ball assembly and the first damper, wherein one side of the second damper that faces the membrane holder is connected to the membrane holder, and one side of the second damper that faces the support frame is connected to the support frame.

2. The vibration system according to claim 1,
wherein the support frame comprises a second frame portion, several support portions, and several installation portions; the number of the installation portions is the same as the number of the first dampers, and the installation portions are arranged concentric with the drive components; the installation portions are located within the second frame portion, and the outer side of the periphery of the installation portions is connected to the second frame portion; the several support portions are arranged around the outer periphery of the second frame portion on a side close to the first damper.

3. The vibration system according to claim 2,
wherein the installation portion comprises several annular portions, and a first connection portion having a first inner hole; the several annular portions are arranged around the circumference of the first connection portion and connected to the second frame portion, and the first inner hole is cooperated and concentric with the drive component.

4. The vibration system according to claim 3,
wherein the first damper comprises a second connection portion having a second inner hole, and piston portions with the same number as the annular portions; the several piston portions are arranged around the circumference of the second connection portion; the piston portions are located within the annular portions and are arranged concentric with the annular portions; the second connection portion is attached to one side of the first connection portion that is close to the membrane holder, and the second inner hole is cooperated and concentric with the drive component.

5. The vibration system according to claim 1,
wherein the fixing portion has a third inner hole therein, and a skeleton portion group is connected between the first holder portion and the fixing portion; the membrane group is attached to the skeleton portion group and can block the skeleton portion group, and the annular membrane is attached to the fixing portion and can block the third inner hole; the third inner hole is cooperated and concentric with the drive component.

6. The vibration system according to claim 5,
wherein the membrane holder further comprises several connecting rod portions; the several connecting rod portions are located on a side of the skeleton portion group located between the outer periphery of the third inner hole and the first holder portion that faces the first damper in a surrounding manner; the connecting rod portions can pass through the first damper and the support frame in sequence and be damped and positioned by the first damper for balance and fixation.

7. The vibration system according to claim 1,
wherein the phase ball assembly is arranged concentric with the drive component, and comprises a mass ball and an annular elastic rubber ring having an installation hole; the mass ball is located within the installation hole and connected to the annular elastic rubber ring.

8. The vibration system according to claim 1,
wherein the second damper is a first annular structure; the first annular structure comprises a third connection portion, a transition portion, and a fourth connection portion; the transition portion is connected to the third connection portion and the fourth connection portion respectively, the third connection portion is connected to the support frame, and the fourth connection portion is connected to the membrane holder.

9. The vibration system according to claim 1,
wherein the second damper is a second annular structure; the second annular structure comprises a fifth connection portion, a corrugated portion provided with spherical structures, and a sixth connection portion; the corrugated portion is connected to the fifth connection portion and the sixth connection portion respectively, the fifth connection portion is connected to the support frame, and the sixth connection portion is connected to the membrane holder.

10. A speaker, comprising the vibration system according to claim 1.
